(19) United States
(12) Patent Application Publication
(10) Pub. No.: US 2015/0152518 A1
(43) Pub. Date: Jun. 4, 2015

(54) Method for Reprocessing an Emulsion Formed During Hydrometallurgical Recovery of a Metal

(71) Applicant: GEA Mechanical Equipment GmbH, Oelde (DE)

(72) Inventors: Ulrich Horbach, Hamm (DE); Jens Kramer, Oelde (DE); Tore Hartmann, Oelde (DE)

(21) Appl. No.: 14/412,268

(22) PCT Filed: Jun. 26, 2013
(86) PCT No.: PCT/EP2013/063331

§ 371 Date: Dec. 31, 2014

(30) Foreign Application Priority Data
Jul. 2, 2012 (DE) 10 2012 105 828.8

(51) Int. Cl. C22B 3/22; B01D 21/26

(52) U.S. Cl. CPC C22B 3/22; B01D 21/262

(57) ABSTRACT

A method for centrifugal reprocessing of a solids-containing emulsion formed during the hydrometallurgical recovery of a metal involves performing the reprocessing in at least one decanter to form a first lighter liquid phase, a second liquid phase, and a solids phase. An actual value of the density of the first liquid phase is determined, the actual value is compared with a desired value for the density of the first liquid phase, and the outlet pressure of the first liquid phase is set in dependence upon the determined actual value/desired value comparison.

### BACKGROUND AND SUMMARY OF THE INVENTION

Exemplary embodiments of the present invention relate to a process for working up an emulsion formed in the hydrometallurgical winning of a metal and to a process for the hydrometallurgical winning of a metal.

In the hydrometallurgical winning of metals, a solids-containing emulsion is formed at the phase boundary between the organic phase and the aqueous phase in a solvent extraction step. This solids-containing emulsion influences the efficiency of the hydrometallurgical winning process since the emulsion forms a relatively large proportion compared to the organic phase and the aqueous phase and can be separated off only with difficulty by means of conventional sedimentation in the sedimentation tanks provided for this purpose. The impurities in the emulsion are carried further both in the organic phase and in the subsequent course of the process through to the electrolyte solution, so that the life of the cathode in the electrochemical winning of the metal is reduced and the setting of the pH of the electrolyte solution becomes problematical. The impurities likewise turn up in the aqueous phase of the solvent extraction, so that this phase cannot readily be recovered from the leaching solution.

PCT international application WO 2006/133804 discloses the use of a decanter for the three-phase separation of an emulsion in the hydrometallurgical winning of a metal. To adjust the separation zone and/or the pond depth in the drum, the pressure is altered in an annular chamber in which a peeling plate is arranged. A fluid feed line through which a fluid, e.g. a gas, can be introduced from the outside opens into the annular chamber. This type of setting/regulation of the separation zone and/or the pond depth has been found to be useful but should be optimized further.

Accordingly, exemplary embodiments of the present invention are directed to an improved process for working up an emulsion formed in hydrometallurgical winning and to an improved process for the hydrometallurgical winning of a metal.

Exemplary embodiments of the invention provide a process for the centrifugal work-up of a solids-containing emulsion formed in the hydrometallurgical winning of a metal, where the work-up is carried out in at least one decanter (full-barrel screw centrifuge) to form a first lighter liquid phase, a second liquid phase and a solids phase, characterized by the following steps:

i) determining an actual value of the density of the first liquid phase,

ii) comparing the actual value with a guide parameter, in particular a prescribed density value, and

iii) setting of the outflow pressure of the first liquid phase as a function of the guide parameter.

The adjustment of the separation zone as a function of the density of the first liquid phase is carried out in such a way or has the consequence that the residence time of this phase in the decanter is optimized so that the phase is discharged with good removal of solids.

As a result the first liquid phase can always be recirculated to the hydrometallurgical process as solvent for the solvent extraction. At the same time, the second liquid phase can also be discharged from the decanter with only low solids contamination and optionally be recirculated as leaching solution to the hydrometallurgical process. At relatively high metal ion concentrations, the first liquid phase, preferably as organic phase, can also be fed to the backextraction in order to achieve maximization of the yield of metal in the hydrometallurgical winning process. In both cases, the efficiency of the hydrometallurgical process is increased. In addition, the solvents used in the hydrometallurgical process can be recovered to a greater extent.

A phase separation to form a first liquid phase, a second liquid phase, and a solids phase is carried out here. A setting of the outflow pressure in the outflow line of a peeling plate for discharge of the first phase is preferably carried out. For this purpose, the density of the first liquid phase is determined as actual value and compared with at least one prescribed value. If the actual value deviates from the prescribed value, the outflow pressure of the first liquid phase is altered.

The regulation is preferably configured in such a way that the system regulates the associated pressure according to the minimum of the density.

In the case of an excessively abrupt increase in the outflow pressure, part of the organic phase could be discharged together with the aqueous phase from the decanter. To avoid this, it is advantageous to determine an additional process parameter and set it to a predetermined prescribed value. This can, for example, be effected by determining the yield, the conductivity and/or the purity of the organic phase and/or the aqueous phase.

The above-described process is also suitable as part of a process for the hydrometallurgical winning of a metal, which preferably comprises the following steps:

A) providing a metal ore;

B) leaching the metal ore to form a metal ion-containing aqueous solution or slurry;

C) solvent extraction to transfer metal ions into an organic solvent phase;

D) backextraction of the metal ions with addition of an electrolyte solution to the organic solvent phase; and

E) electrochemical winning of the metal.

A solids-containing emulsion is formed during the solvent extraction and this is worked up by one of the above processes. The work-up of the emulsion improves the efficiency of the hydrometallurgical winning process. Fluctuations caused by the inhomogeneous composition of the metal ore, in particular by a changing proportion of silicates or sand, influence the efficiency of the hydrometallurgical winning process to only a small extent.

To achieve an efficient mode of operation, it is particularly advantageous that the liquid phases recovered from the emulsion can be recirculated as organic solvent or leaching liquid to the extraction process, so that an environmentally friendly and economical mode of operation is made possible.

An advantageous variant of the invention is illustrated below with the aid of the drawings.

### BRIEF DESCRIPTION OF THE DRAWING FIGURES

The drawings show:

FIG. 1: a schematic depiction of a hydrometallurgical process for winning a metal;

FIG. 2: a schematic depiction of a subregion of a decanter for working up an emulsion;

FIG. 3: a schematic depiction of an operating state with a relatively low outflow pressure in the outflow line downstream of a peeling plate of the decanter;

FIG. 4: a schematic depiction of an operating state with an increased outflow pressure compared to FIG. 3;

FIGS. 5-7: various graphs to illustrate the prevailing relationships in the processing of the emulsion.

### DETAILED DESCRIPTION

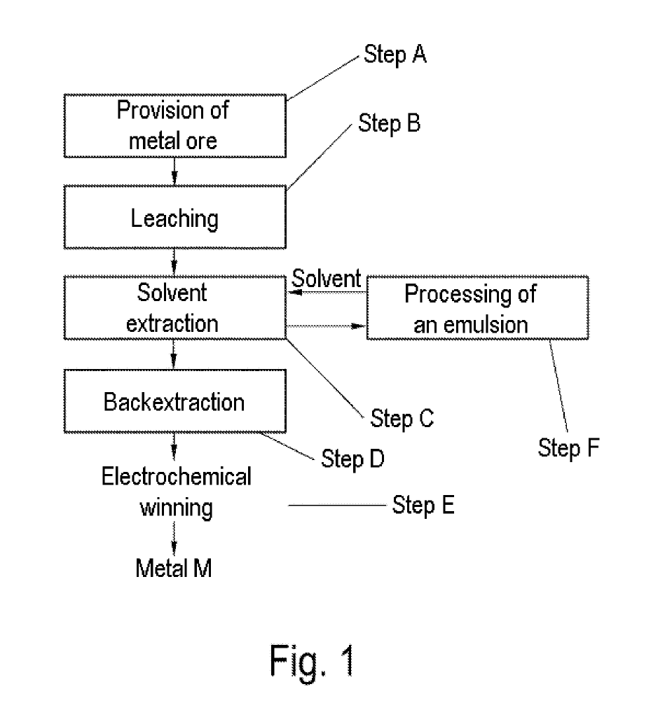

FIG. 1 shows an exemplary process flow diagram for the hydrometallurgical winning of a metal.

Proceeding from the provision of a metal ore in step A, for example a copper-, nickel- or cobalt-containing ore, leaching of the metal ore is first carried out in step B. A leaching solution is added here. As a result, metal ions are at least partially dissolved. The leaching solution is preferably an aqueous solution.

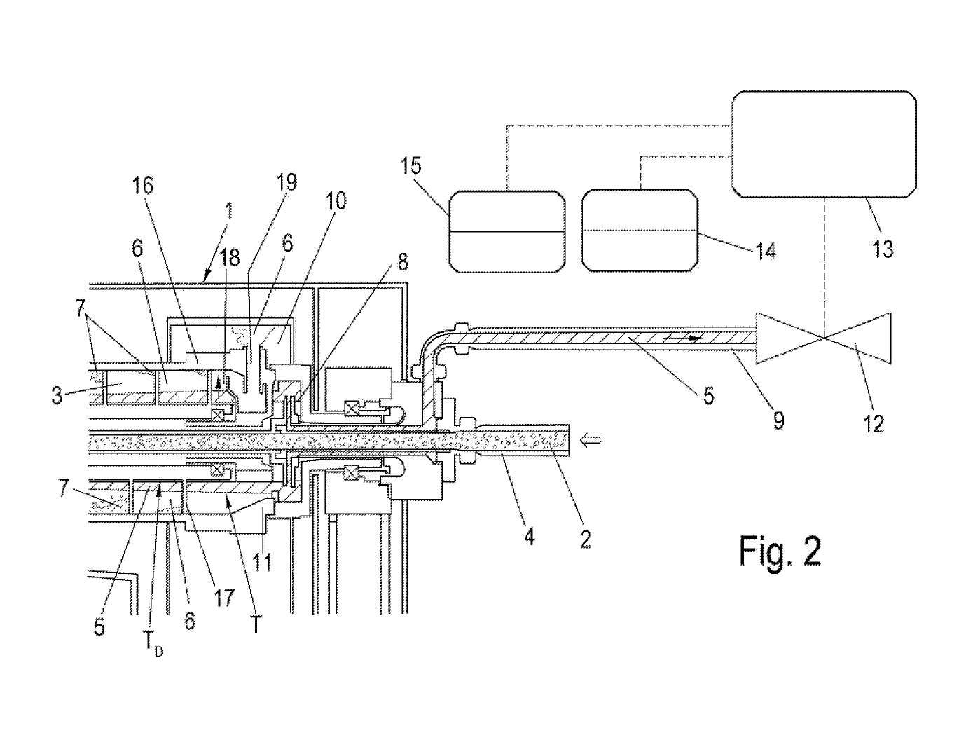

After leaching, a solvent extraction is carried out in step C. Here, an organic solvent is preferably added to the leaching solution to form a two-phase system composed of an organic phase and an aqueous phase but in which a solids-containing emulsion is formed at the phase boundary because of the impurities. The work-up is described in more detail below with reference to FIGS. 2-7.

After the metal ions have been transferred into the organic phase, a backextraction is carried out in step D by addition of an aqueous electrolyte solution, with the organic phase being able to be recovered so as to be reused in the preceding solvent extraction.

After the solvent extraction and the backextraction, the electrochemical winning and optionally additional refining of the metal M is carried out in step E, taking into account the deposition potential of the respective metal.

FIG. 2 illustrates an advantageous way of working up the emulsion formed in the solvent extraction during the hydrometallurgical winning of a metal, as shown in FIG. 1.

Particular preference is given to using a decanter, in particular a three-phase decanter, for working up the emulsion.

In the case of the three-phase decanter 1 shown in FIG. 2, emulsion 2 to be worked up is introduced via a feed tube 4 into a drum interior 3 of a drum 16.

This emulsion 2 is separated in the centrifugal field of the drum 16 of the decanter 1 into an organic phase 5, an aqueous phase 6 and a solids phase 7. A separation zone diameter T and a pond depth or a pond depth diameter TD are formed.

The organic phase 5 is discharged from the decanter 1 via a peeling plate 8 with peeling plate shaft and an outflow line 9 arranged downstream of this by means of a pump (not shown).

The heavier aqueous phase 6 is, by way of example, discharged radially from the decanter interior 3 at an outlet 19, collected in the collection space 10 and from there discharged from the decanter.

The solids phase 7 is preferably conveyed by means of a screw 17 on a side of the drum 16 opposite the outlet for the organic phase 5 and there discharged from the drum 16 (not shown).

A weir 11, via which the organic phase 5 flows to the peeling plate 8, is arranged in the drum interior 3.

The weir 18 serves, in contrast, as discharge overflow for the aqueous phase 7 to the preferably radial outlet from the drum 16.

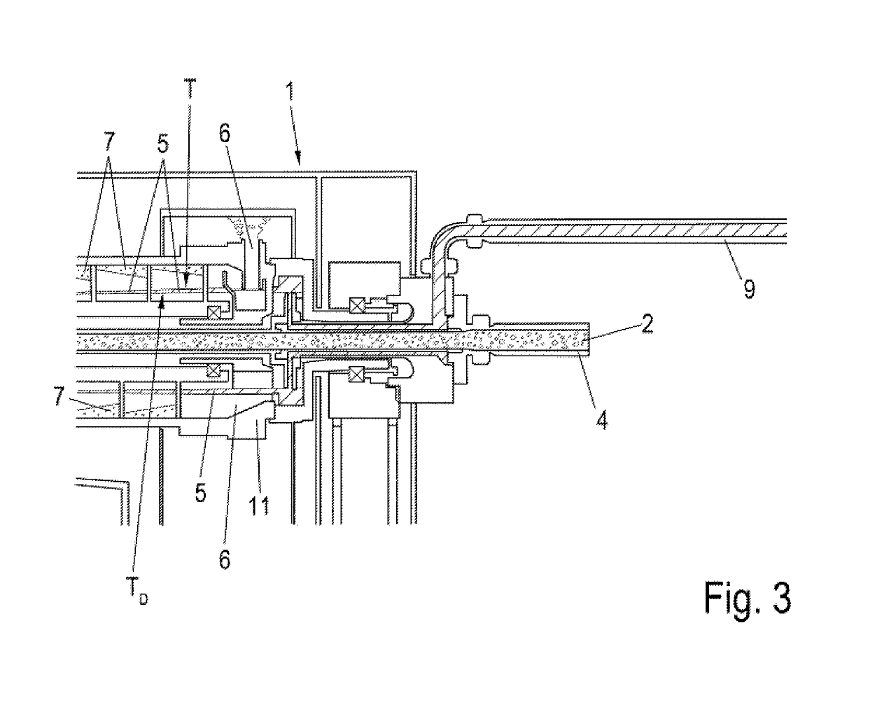

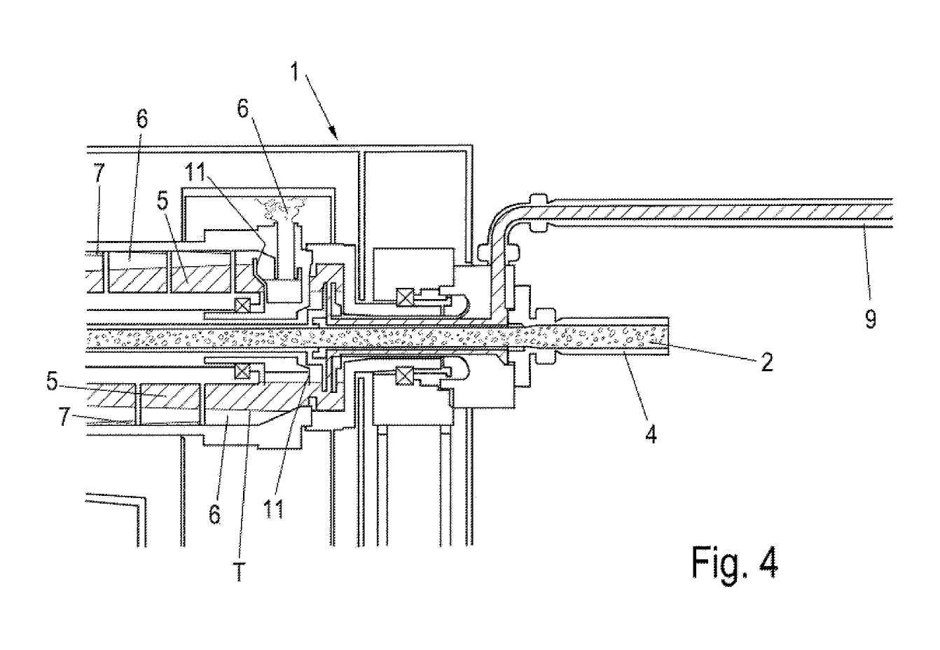

To set the separation zone or the separation zone diameter T (see also FIGS. 3 and 4) in the decanter 1, a valve 12 installed in the outflow line 9 is switched; this valve 12 can be controlled via a regulating device 13 for adjusting the valve 12 as a function of a process parameter, in particular as a function of the pressure of the organic phase.

This regulating device 13 has at least one means for determining a process parameter. A preferred means for determining the process parameter is preferably a means for density measurement 14, in particular for measuring the density of the organic phase 5.

If the density deviates from a guide parameter (preferably a fixed or variable prescribed density value which reflects a maximum contamination of the organic phase 5) or a prescribed density value associated therewith, the degree of throttling of the value 12 is altered appropriately.

Increased throttling of the valve 12 results in less light phase 5 being discharged, as a result of which the diameter of the separation zone T in the drum 16 of the decanter is shifted outward and at the same time the pond depth DT is increased radially in an inward direction.

The adjustment of the outflow pressure associated with adjustment of the valve 12 brings about a shift of the separation zone T in the decanter as a function of the density of the organic phase. An increase in the density of the organic phase is equivalent to an increase in contamination of this phase. Determination of the density makes it possible to detect contamination in the organic phase 5 in a simple way. A fixed or variable prescribed value for the density gives the upper limit for possible contamination. If this is exceeded, countermeasures for reducing the density are undertaken, e.g. altering the outflow pressure in the outflow line 9. Determination of the density thus allows automatic adaptation of the mode of operation of the decanter in continuous operation.

FIG. 3 shows a possible state of the decanter 1 in which the valve 12 (not shown here) has not been throttled or throttled only very slightly. In this state, the organic phase is present in only a very small amount.

If the contamination of the valuable organic phase increases, this increased contamination can be determined by the means shown in FIG. 2 for density measurement 14, e.g. in the outflow line 9, and the valve 12 can subsequently be throttled to increase the outflow pressure. The increased outflow pressure shifts the separation zone T outward, so that a smaller amount of solids is present in the region of the outflow for the organic phase and the aqueous phase. In addition, the pond zone diameter TD moves radially inward. FIG. 4 shows the state of the decanter 1 in the case of a more greatly throttled pressure valve 12 compared to FIG. 3, in which state the outflow pressure is increased, which shifts the separation zone T further outward and the pond depth TD inward.

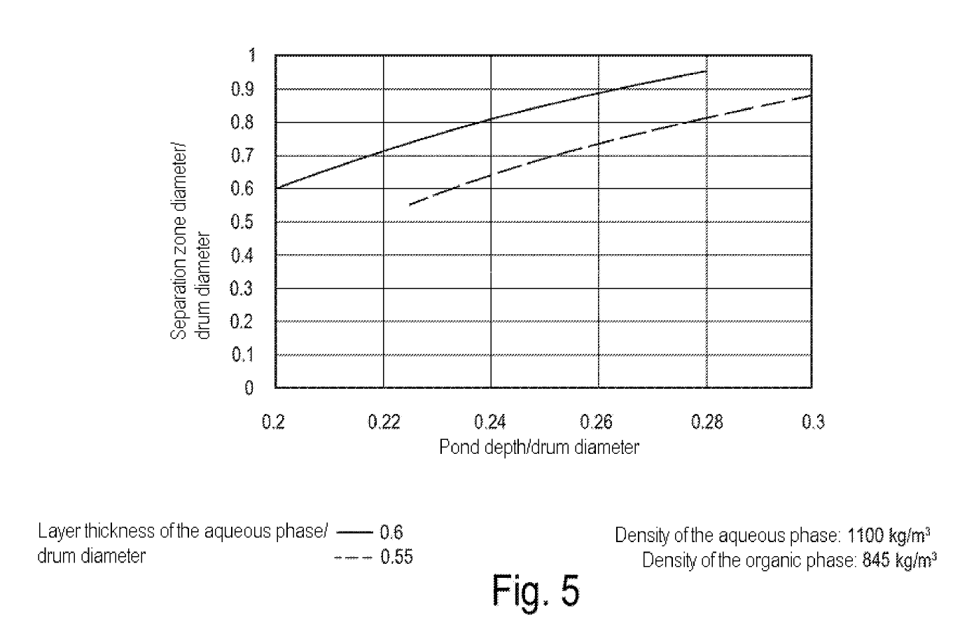

The graph in FIG. 5 schematically shows the dependence of the ratio of separation zone diameter T/drum diameter on the ratio of pond depth Td/drum diameter.

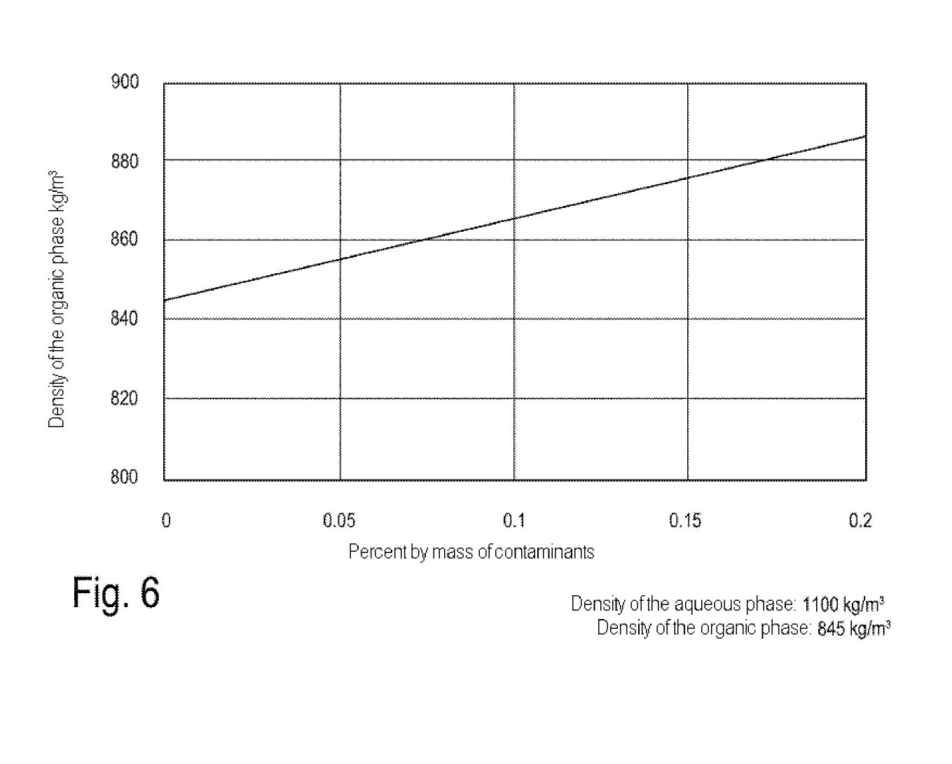

The graph in FIG. 6 describes the dependence of the density of the contaminated organic phase on the degree of contamination. A pure organic phase has a density of 845 kg/m3. However, this density increases further, preferably linearly, with increasing contamination. A direct conclusion as to the prevailing contamination can therefore be drawn by determining the density of the organic phase.

Such a graph is determined experimentally. The outlet pressure which is particularly advantageous at a given contamination is also determined in the experiment. Such a relationship can then be stored in the computer and employed for determining the outflow pressure to be set.

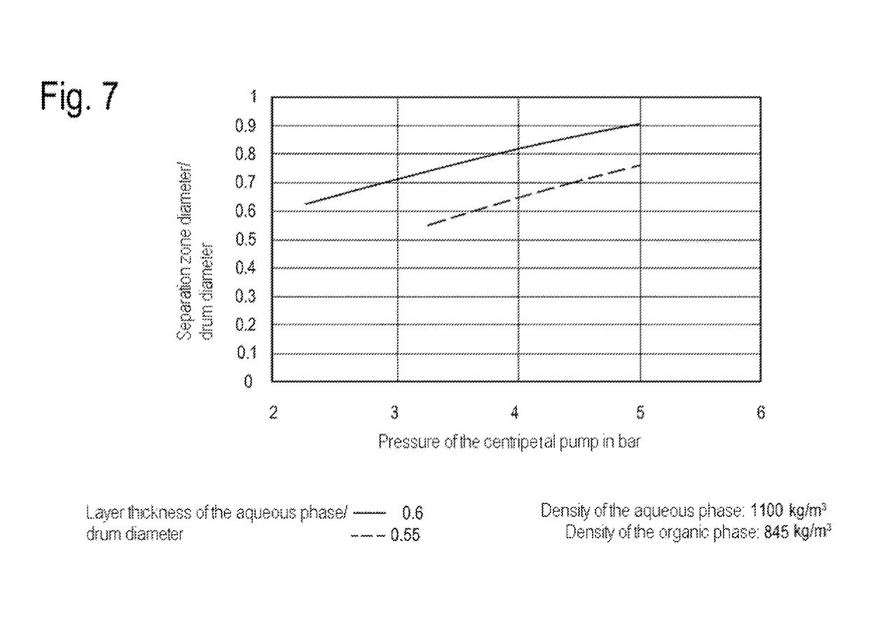

Thus, the graph of FIG. 7 shows the dependence of the separation zone diameter to the drum diameter T on the pressure at the peeling plate or centripetal pump as a result of throttling of the valve 12.

It can be seen that when the pressure generated by the pump increases, the separation zone diameter T increases in an outward direction. The increase in the separation zone diameter T corresponds to an increase in the volume of organic phase in the drum and thus an increase in the retention time, i.e. the time which the organic phase takes to run through the decanter.

The increase in the separation zone diameter T thus also results in a higher purity of the organic phase. The adaptation of the outflow pressure and, associated therewith, the separation zone diameter T as a function of the measured density of the organic phase can be carried out in real time in a continuous process.

However, if the outflow pressure increases too greatly, for example as a result of a large reduction in the outflow volume of the organic phase, an organic phase having a high purity is obtained but in this case part of the organic phase is lost during discharge of the aqueous phase. Solids are sometimes also lost in this way. In this case, an additional determination and adjustment of the yield, the conductivity and the purity of the organic phase or optionally also the aqueous phase can be carried out. The yield can, for example, be determined using means for measuring the volume flow 15, which means are, as shown in FIG. 2, arranged in the region of the outlet for the organic phase.

It should be noted that suitable means for measuring the density are known to those skilled in the art. Mention may be made of optical methods (shining light through the phase: increase in turbidity indicates an increase in density). Furthermore, other suitable means for density measurement can be employed. The density measurement is preferably carried out continuously, for example on the product exiting from the outflow line 9.

The experiments were carried out using a decanter centrifuge model DCE 345 02.32 from GEA WESTFALIA GROUP GMBH, Oelde, Germany.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### REFERENCE NUMERALS

1 Decanter
2 Emulsion
3 Decanter interior
4 Feed tube
5 Organic phase
6 Aqueous phase
7 Solids phase
8 Peeling plate
9 Outflow line
10 Collection space
11 Weir
12 Valve
13 Regulator
14 Means for density measurement
15 Means for measuring the volume flow
16 Drum
17 Screw
18 Overflow weir
19 Outlet
Step A Provision of metal ore
Step B Leaching
Step C Solvent extraction
Step D Backextraction
Step E Electrochemical winning
Step F Work-up of the emulsion
M Metal
T Separation zone
Td Pond depth

1-7. (canceled)

8. A process for the centrifugal work-up of a solids-containing emulsion formed in the hydrometallurgical winning of a metal, the method comprising:
performing the work-up in a decanter to form a first lighter liquid phase, a second liquid phase, and a solids phase;
determining an actual value of a density of the first liquid phase;
comparing the actual value of the density with a guide parameter, wherein the guide parameter is a prescribed density value; and
setting an outflow pressure of the first liquid phase as a function of the guide parameter.

9. The process of claim 8, wherein the outflow pressure is set by throttling a valve in an outflow line downstream of a peeling plate for discharging the first liquid phase from the decanter.

10. The process of claim 8, wherein the first liquid phase has a lower density than the second liquid phase.

11. The process of claim 8, wherein the work-up forms an organic phase, an aqueous phase, and a solids phase, wherein the organic phase is the first liquid phase and the aqueous phase is the second liquid phase.

12. The process of claim 8, wherein the decanter is a three-phase decanter.

13. The process of claim 8, wherein a further regulating parameter is determined in addition to the density and the further regulating parameter is accounted for in the setting of the outflow pressure.

14. The process claim 13, wherein a yield, conductivity, or purity of the first liquid phase or the second liquid phase is employed as the additional regulating parameter.
